(19) United States
(12) Patent Application Publication
(10) Pub. No.: US 2008/0068952 A1
(43) Pub. Date: Mar. 20, 2008

(54) Track Jump Control Circuit

(75) Inventors: Yoshihisa Yamada, Aichi (JP); Tomonori Kamiya, Aichi (JP)

Correspondence Address: FISH & RICHARDSON P.C., P.O. BOX 1022, MINNEAPOLIS, MN, 55440-1022, US

(73) Assignees: SANYO ELECTRIC CO., LTD., Osaka (JP); SANYO SEMICONDUCTOR CO., LTD., Gunma (JP)

(21) Appl. No.: 11/854,977

(22) Filed: Sep. 13, 2007

(30) Foreign Application Priority Data
Sep. 14, 2006 (JP) 2006-249467

(51) Int. Cl. G11B 5/58

(52) U.S. Cl. 369/53.17

(57) ABSTRACT

A track jump control circuit performing control for an optical pickup to ump from a present scanning track position to a target scanning track position on an optical disc including a header portion and a data portion, through counting the number of pulses of a binarized tracking error signal, the track jump control circuit comprising: a counter configured to count in an edge interval of the binarized tracking error signal; a holding circuit configured to hold a count value obtained by the counter; a correction process circuit configured to generate a correction signal of the binarized tracking error signal, using a count value held in the holding circuit and the binarized tracking error signal; and a selector configured to select and output the binarized tracking error signal or the correction signal, corresponding to a header portion detection signal indicating passage of the optical pickup through the header portion.

### CROSS-REFERENCE TO RELATED APPLICATION

This application claims the benefit of priority to Japanese Patent Application No. 2006-249467, filed Sep. 14, 2006, of which full contents are incorporated herein by reference.

### BACKGROUND OF THE INVENTION

1. Field of the Invention

The present invention relates to a track jump control circuit.

2. Description of the Related Art

A DVD-RAM medium is a DVD medium capable of recording, reproducing, and erasing data, and is in popular use mainly as a large-capacity recording medium for computer.

FIG. 10 depicts the disc format of a DVD-RAM. An optical disc 10 is a DVD-RAM medium, and has a plurality of zones 15a to 15z that are set in a radial direction. With respect to each of the zones 15a to 15z, as the zone goes from a zone on the inner periphery to a zone on the outer periphery, the rotation speed of the optical disc 10 at the zone gets lower, and the number of sectors per track contained in each of the zones 15a to 15z varies accordingly. The track contained in each of the zones 15a to 15z is divided into sectors, each of which has a header portion 11 on which header information, such as a physical ID, is prerecorded by CAPA (Complimentary Allocated Pit Addressing) method, and a data portion 12 for recording data thereon.

FIG. 11 is an explanatory view of the header portion 11. The header portion 11 is provided between data portion 12a and a data portion 12b that are adjacent to each other for every sector. As to the header portion 11, embossed pits 16a to 16f indicating header information are recorded on positions which are shifted by a half track relative to the track of the data portions 12a and 12b.

An optical disc apparatus 700 used for recording/reproduction for the optical disc 10 has a structure shown in FIG. 12. When performing random reproduction, for example, the optical disc apparatus 700 performs seek operation to cause an optical pickup 750 to track jump in scanning position from a present scanning track position T1 to a target scanning track position T2 (e.g., see Japanese Patent Application Laid-Open Publication No. 2000-163764).

Specifically, the optical disc apparatus 700 drives a spindle motor 705 through a spindle servocontrol circuit 710 to rotate the optical disc 10, in response to a recording or reproduction command from an external host computer 600. In consequence, there may occur disc wobbling and track wobbling resulting from the rotation of the optical disc 10. Therefore, the optical disc apparatus 700 drives an objective lens (not shown) of the optical pickup 750 in a focus direction (parallel with an optical axis) or in a tracking direction (orthogonal to the optical axis) based on a focus error signal FE or a tracking error signal TE by operating a focus servo control circuit 720 and a tracking error servo control circuit 730, to adjust the two-dimensional position of a light spot S formed on the optical disc 10.

The optical disc apparatus 700 then performs so-called “long jump”, which is an operation to move the scanning position of the optical pickup 750: from the present scanning track position T1, at which the light spot S is scanning at present; to the vicinity of the target scanning track position T2, the target scanning track including a target sector which is an object for recording or reproduction, is included in the target scanning track. Such long jump can be referred to as a mechanism for making rough adjustment of the scanning position of the light spot S, meaning a track jump of a plurality of zones out of zones 15a to 15z.

Specifically, the optical disc apparatus 700 reads the header information out of the header portion 11 of each sector of the optical disc 10 to detect the present scanning track position T1, and determines whether the present scanning track position T1 coincides with the target scanning track position T2. When the present scanning track position T1 does not coincide with the target scanning track position T2, the optical disc apparatus 700 calculates a target number of tracks to be jumped, which indicates how many tracks the optical disc apparatus 700 should be moved toward the inner periphery or the outer periphery, based on the difference between the present scanning track position T1 and the target scanning track position T2.

The optical disc apparatus 700 causes a track jump control circuit 740 to supply a long jump signal based on the target number of tracks to be jumped to a sled motor (generally, stepping motor) that drives a sled mechanism (not shown) of the optical pickup 750, thereby moving the optical pickup 750 in the radial direction. When supply of the long jump signal to the sled motor comes to a stop, the movement of the optical pickup 750, that is, the long jump comes to an end.

Following the long jump, the optical disc apparatus 700 performs the so-called “short jump”, which makes a fine adjustment to the scanning position of the light spot S and determines the position thereof. Being different from the long jump, the short jump is a track jump which moves the position of the light spot S by using a servo mechanism (not shown) including a lens holder holding the objective lens, a driving coil disposed in the lens holder, etc.

Specifically, following the long jump, the optical disc apparatus 700 operates the track jump control circuit 740 to move the objective lens of the optical pickup 750 in the radial direction so that the present scanning track position T1, at which the light spot S is scanning at present, coincides with the target scanning track position T2. When making such a movement, the optical disc apparatus 700 slices the tracking error signal TE of an analog value, to generate a binarized tracking error signal TES in a pulse train. The number of pulses including in the binarized tracking error signal TES is equivalent to the number of the tracks jumped by the light spot S in the above movement.

Thus, the track jump control circuit 740 counts the number of the tracks jumped by the light spot S, by counting the number of pulses including in the binarized tracking error signal TES. The track jump control circuit 740 brings the short jump to an end thereby finishes seek operation, at the point that the counted number of jumped tracks coincides with a target number of tracks to be jumped.

If the light spot S passes not across the data portion 12 but across the header portion 11 when jumping tracks during the track jump, the tracking error signal TE, which is an analog value, is distorted because the amount of reflection light from the header portion 11 is different from that from the data portion 12 due to the effect of the embossed pits 16, etc. This leads to the generation of a useless pulse or a lack of a pulse in the pulse train of the binarized tracking error signal TES. Such pulse train disorder of the binarized tracking error signal TES results in an error in the count value of the number of tracks jumped by the light spot S, so that the track jump cannot be performed normally, thus the present scanning track position T1 does not coincide with the target scanning track position T2, which is a problem.

### SUMMARY OF THE INVENTION

A track jump control circuit according to an aspect of the present invention, which performs control for an optical pickup to jump from a present scanning track position to a target scanning track position on an optical disc including a header portion on which header information is prerecorded and a data portion on which data is recorded, through counting the number of pulses of a binarized tracking error signal generated from reflected light from the optical disc received by the optical pickup, comprises: a counter configured to count in an edge interval of the binarized tracking error signal; a holding circuit configured to hold a count value obtained by the counter; a correction process circuit configured to generate a correction signal of the binarized tracking error signal, using a count value held in the holding circuit and the binarized tracking error signal; and a selector configured to select and output the binarized tracking error signal or the correction signal, corresponding to a header portion detection signal indicating passage of the optical pickup through the header portion.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram of a configuration of an optical disc apparatus according to one embodiment of the present invention;

FIG. 2 is an explanatory view of an operation of a header portion detection signal generating circuit according to one embodiment of the present invention;

FIG. 3 is a diagram of a configuration of a track jump control circuit and peripheral circuits thereof according to one embodiment of the present invention;

FIG. 4 is a diagram of the configuration of a TES correction circuit according to one embodiment of the present invention;

FIG. 5 is an explanatory view of setting of a TES correction effective flag by a microcomputer according to one embodiment of the present invention;

FIG. 6 is a flowchart for describing a TES correction process by the TES correction circuit according to one embodiment of the present invention;

FIG. 7 is a waveform chart of main signals for describing the TES correction process by the TES correction circuit according to one embodiment of the present invention;

FIG. 8 is a flowchart for describing a preinterpolation process by the TES correction circuit according to one embodiment of the present invention;

FIG. 9 is a waveform chart of main signals for describing the preinterpolation process by the TES correction circuit according to one embodiment of the present invention;

FIG. 10 is an explanatory view of the disc format of a DVD-RAM;

FIG. 11 is an explanatory view of a header portion of the DVD-RAM; and

FIG. 12 is a diagram of a configuration of a conventional optical disc device.

### DETAILED DESCRIPTION OF THE INVENTION

At least the following details will become apparent from descriptions of this specification and of the accompanying drawings.

<Configuration of Optical Disc Apparatus>

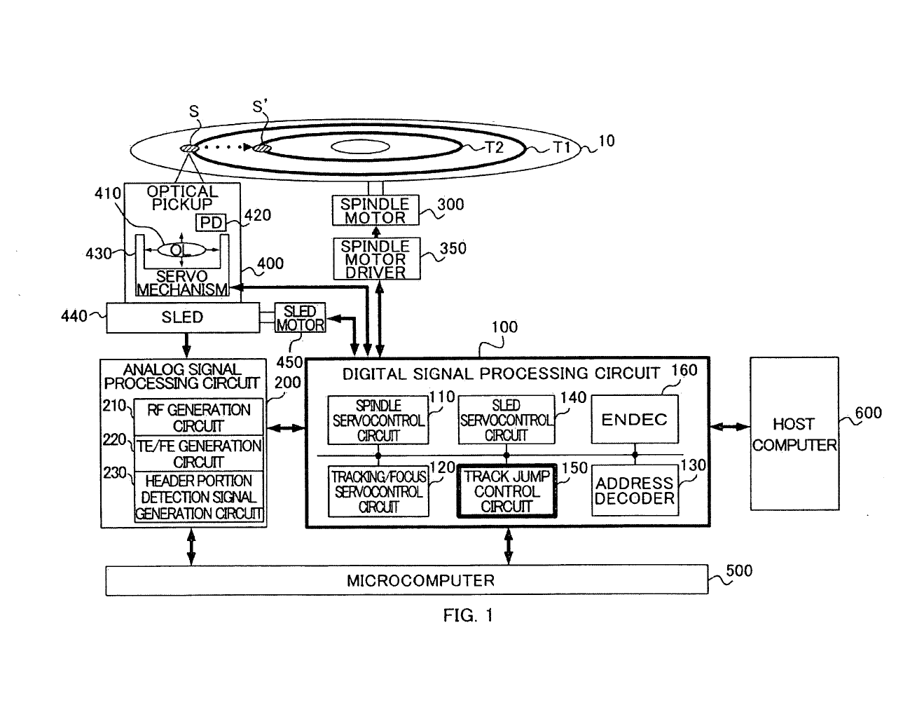

FIG. 1 is a diagram of a configuration of an optical disc apparatus according to one embodiment of the present invention.

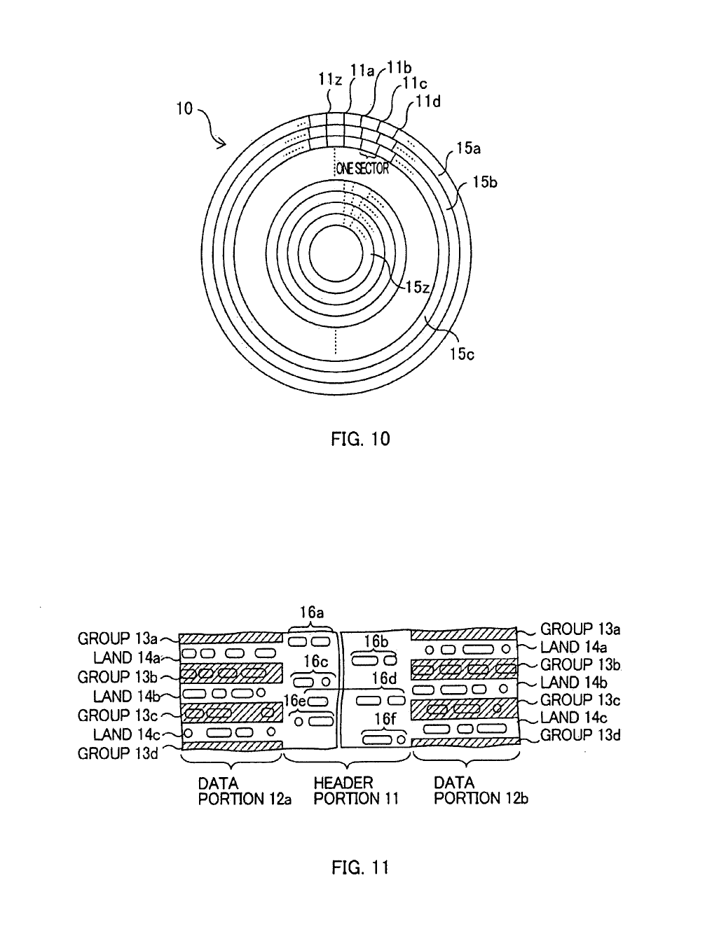

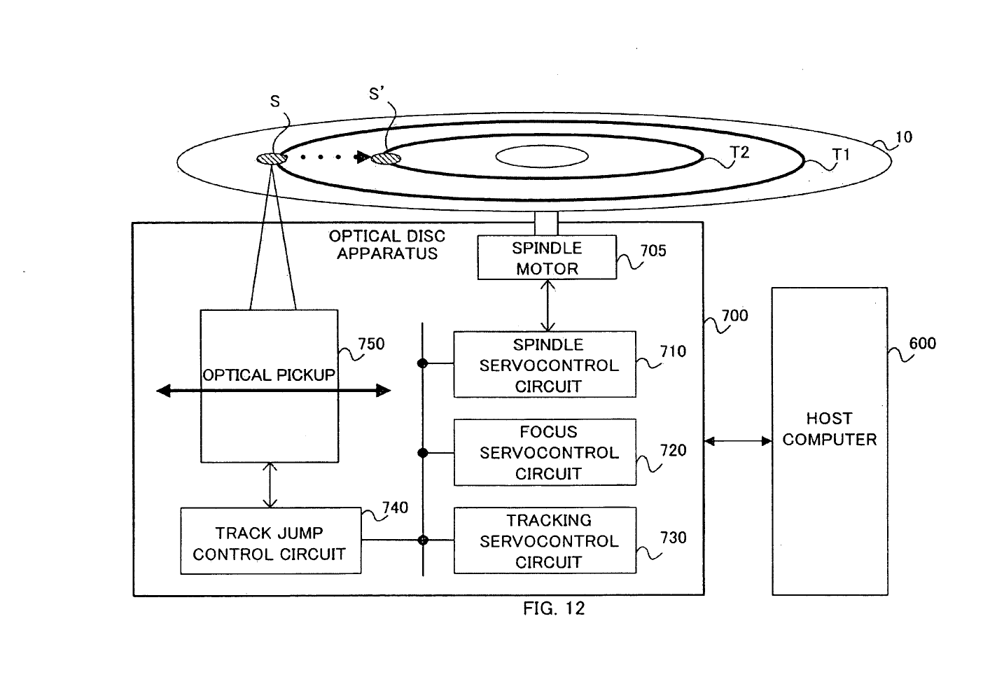

The optical disc 10 is a DVD-RAM medium, conforming to a disc format shown in FIG. 10. The optical disc 10 includes a plurality of zones 15a to 15z that are set in the radial direction concentrically. A track (groups 13a to 13d or lands 14a to 14c shown in FIG. 11) disposed in each of the zones 15a to 15z is divided into sectors including header portions 11a to 11z on which header information, such as physical IDs, is prerecorded and data portions 12a and 12b for recording data thereon. As to the header portion 11, embossed pits 16a to 16f for recording header information are recorded on positions which are shifted by a half track relative to the track of the data portions 12a and 12b, as shown in FIG. 11. The optical disc 10 may be an optical disc other than the DVD-RAM medium, which optical disc conforms to a disc format, where each of the header portions 11a to 11z is formed in advance at the head of each sector, as described above.

A spindle motor 300 is a motor that is mounted to a turntable for the optical disc 10 and that drives a spindle motor driver 350 to rotate the optical disc 10.

A sled 440 is a mechanism for “long jump”, which supports an optical pickup 400 so as to face the surface of the optical disc 10 and which moves the whole of the optical pickup 400 including an objective lens 410 in the radial direction of the optical disc 10. The long jump is a track jump which moves the position of a light spot S formed by condensing a light from the optical pickup 400 on the optical disc 10: from a present scanning track position T1, at which the optical spots is scanning at present; to the vicinity of a target scanning track position T2, the target scanning track including a recording or reproduction object sector. This track jump is performed for making rough adjustment of the scanning position of the optical pickup 400.

A sled motor 450 is a motor for moving the sled 440, and a stepping motor is usually adopted therefore which is operated by a microstep driving method of determining a reference step angle according to the reference value of an exciting current.

The optical pickup 400 comprises the objective lens 410 and other optical lenses for condensing laser light emitted from a semiconductor laser (not shown) onto the optical disc 10 as the optical spot S, a photodetector 420 of four-part split diode, etc., which receives reflected light from the optical disc 10, and a servomechanism 430 for focusing/tracking servo.

The servomechanism 430 includes a lens holder holding the objective lens 410, a board elastically supporting the lens holder with a suspension wire, a driving coil provided for the lens holder, and magnetic members such as a magnet and a yoke that have a magnetic effect caused by driving the driving coil. That is, the objective lens 410 is driven in a focus direction (parallel with an optical axis) and in a tracking direction (orthogonal to the optical axis), by the magnetic effect caused by driving the driving coil.

The servomechanism 430 is used as a focusing servomechanism and as a tracking servomechanism, and is also used as a mechanism for “short jump”. The Short jump is a track jump that makes a fine adjustment, following the long jump, so that the scanning position of the light spot S coincides with the target scanning track position T2, to determine the position of the optical pickup 400.

An analog signal processing circuit 200 includes an RF generating circuit 210, a TE/FE generating circuit 220, and a header portion detection signal generating circuit 230.

The RF generating circuit 210 generates an RF signal of an analog value based on reflected light from the optical disc 10, which is detected by the photodetector 420. A binarized RF signal obtained by binarizing the RF signal is supplied to a digital signal processing circuit 100.

The TE/FE generating circuit 220 generates a tracking error signal TE for tracking servo and a focus error signal FE for focus servocontrol based on reflected light from the optical disc 10, which is received by the photodetector 420. For example, the tracking error signal TE is generated by a three-beam method, a push-pull method, or a DPD (Differential Phase Detection) method, and the focus error signal FE is generated by an astigmatic method or a Foucault method. A binarized tracking error signal TES obtained by binarizing the tracking error signal TE is supplied to a digital signal processing circuit 100.

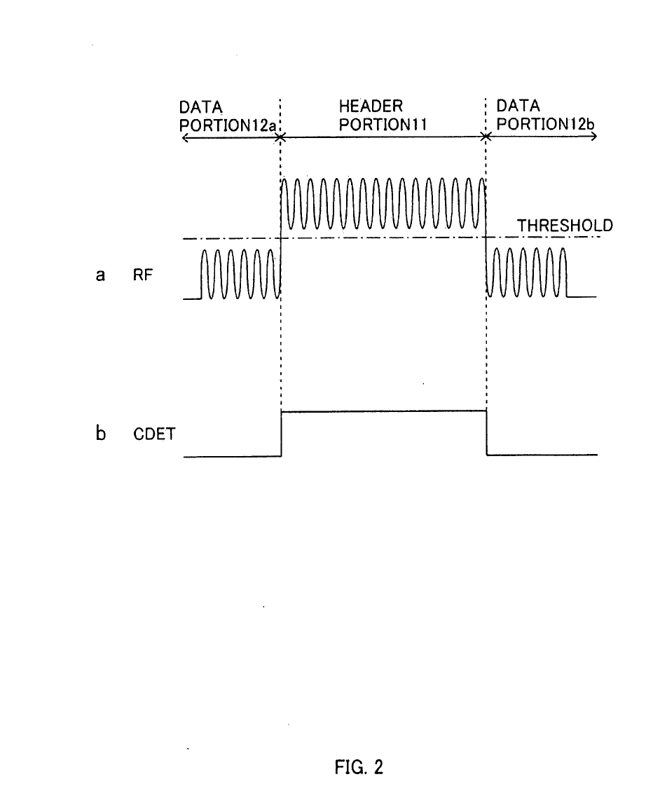

The header portion detection signal generating circuit 230 generates, based on the RF signal, a header portion detection signal CDET which indicates that the light spot S has passed the header portion 11, to be supplied to the digital signal processing circuit 100. To describe more specifically referring to FIG. 2, the RF signal is obviously different in level in between the header portion 11 and the data portion 12 due to the different light amount of the reflected light therebetween, as shown in FIG. 2a. Therefore, as shown in FIG. 2b, by slicing the RF signal with a predetermined threshold, there is generated the header portion detection signal CDET with a high level pulse, which forms a rising edge when the light spot S starts passing the header portion 11 and forms a falling edge when the light spot S has passed the header portion 11. The header portion detection signal CDET may have such a waveform that a low level pulse emerges at a point corresponding to the passage of the light spot S through the header portion 11.

The digital signal processing circuit 100 includes a spindle servocontrol circuit 110, a tracking/focus servocontrol circuit 120, an address decoder 130, a sled servocontrol circuit 140, a track jump control circuit 150, and an encoder/decoder 160. The digital signal processing circuit 100 may be an analog-digital LSI that is an integrated circuit including the digital signal processing circuit 100 and the analog signal processing circuit 200.

The spindle servocontrol circuit 110 generates a bit clock signal having a frequency in proportion to the rotation speed of the optical disc 10 based on the binarized RF signal generated by the RF generating circuit 210. The spindle servocontrol circuit 110 compares this bit clock signal with a reference clock signal corresponding to the specified rotation speed of a spindle motor 300, and supplies a drive voltage corresponding to the result of the above comparison to a spindle motor driver 350, thereby controls the spindle motor 300 in rotation speed so that the spindle motor 300 rotates at the specified rotation speed. The specified rotation speed of the spindle motor 300 varies with each of the zones 15a to 15z of the optical disc 10.

The tracking/focus servocontrol circuit 120 generates and supplies a drive voltage for driving various driving coils of the servo mechanism 430 based on the tracking error signal TE and focus error signal FE generated by the TE/FE generating circuit 220, to perform tracking servocontrol of causing the light spot S to follow a target scanning track and focus servocontrol of focusing the light spot S.

The address decoder 130 decodes header information on the header portion 11 of one sector that the light spot S is scanning at present, based on the binarized RF signal generated by the RF generating circuit 210. As a result, a microcomputer 500 can grasp the present scanning track position T1 of the light spot S in performing the long jump or the short jump.

The sled servocontrol circuit 140 performs sled servocontrol of the sled 440 supporting the optical pickup 400 to move by driving the sled motor 450 in such a manner that the scanning position of the optical pickup 400 long-jumps from the present scanning track position T1 to the target scanning track position T2.

Specifically, the sled servocontrol circuit 140 detects the present scanning track position T1 based on the header information decoded by the address decoder 130, and determines whether the present scanning track position T1 coincide with the target scanning track position T2 specified by the microcomputer 500. When the present scanning track position T1 does not coincide with the target scanning track position T2, the sled servocontrol circuit 140 calculates a target number of tracks to be jumped, which indicates how many tracks the optical pickup 400 should be moved toward the inner periphery or the outer periphery, based on the difference between the present scanning track position T1 and the target scanning track position T2.

The sled servocontrol circuit 140 supplies to the sled motor 450 a jump signal (drive voltage) based on the target number of tracks to be jumped, to move the optical pickup 400 in the radial direction. When the supply of the jump signal to the sled motor 450 comes to a stop, the movement of the optical pickup 400, i.e., the long jump comes to an end.

Following the long jump, the track jump control circuit 150 performs the short jump, by which the objective lens 410 of the optical pickup 400 is moved in the radial direction of the optical disc 10 so that the present scanning track position T1, at which the light spot S is scanning at present, coincides with the target scanning track position T2. The number of pulses included in the binarized tracking error signal TES, which is generated in performing the above short jump, is equivalent to the number of tracks jumped by the light spot S in the above movement.

Thus, the track jump control circuit 150 counts the number of tracks jumped by the light spot S in of the movement, by counting the number of pulses including in the binarized tracking error signal TES. The track jump control circuit 150 brings the short jump to an end, at the point that the counted number of jumped tracks coincides with a target number of tracks to be jumped.

The encoder/decoder 160 performs an encoding process or a decoding process corresponding to the DVD-RAM standard. For example, the encoding process includes a scrambling process, the generation and addition process of an error correction code and an error detection code, and an EFM (Eight-to-Fourteen Modulation) plus modulation process, which are performed on write data transmitted from a host computer 600. The decoding process includes the error correction and error detection process, an EFM plus modulation process, and a descrambling process, which are performed on read data (binarized RF signal) read out of the optical disc 10.

The microcomputer 500 is a system controller that controls the whole of the optical disc apparatus including the digital signal processing circuit 100, analog signal processing circuit 200, and optical pickup 400.

The host computer 600 is, for example, such an external device as personal computer equipped with a DVD-RAM drive, sends a recording command and a reproduction command to the optical disc apparatus, and transmits write data before the encoding process and receives read data after the decoding process.

<Configuration of Track Jump Control Circuit and Peripheral Circuits Thereof>

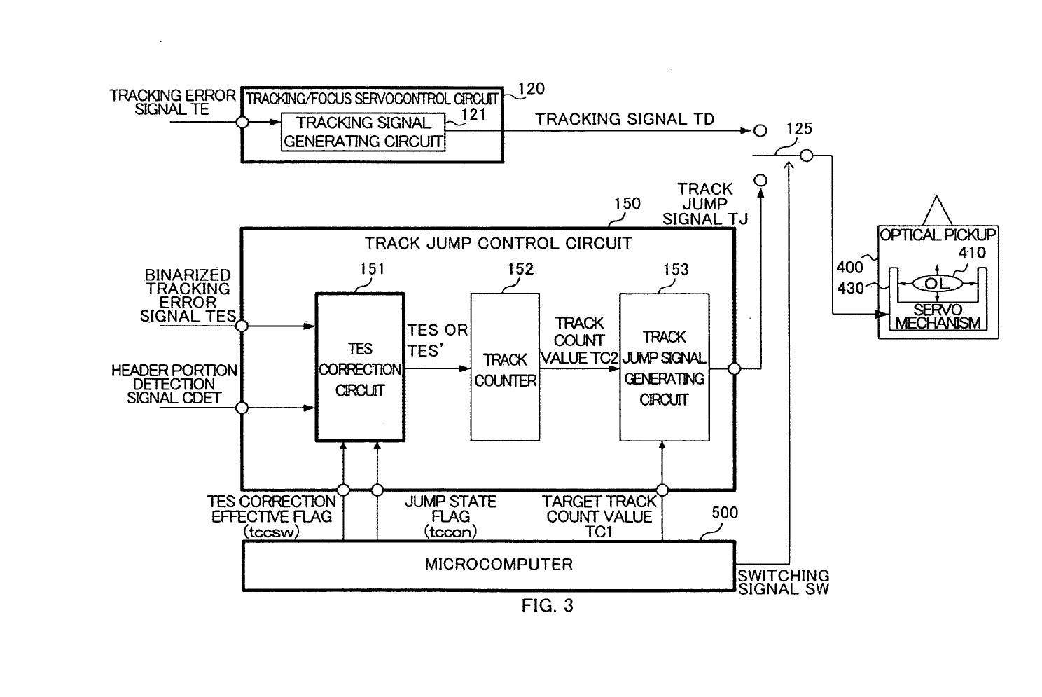

FIG. 3 is a diagram of a configuration of the track jump control circuit 150 and peripheral circuits thereof according to one embodiment of the present invention.

The peripheral circuits of the track jump control circuit 150 include the microcomputer 500, a tracking signal generating circuit 121 of the tracking/focus servocontrol circuit 120, a two-input switch circuit 125, and the servo mechanism 430 of the optical pickup 400.

The microcomputer 500 supplies the track jump control circuit 150 with: a TES correction effective flag tccsw that is set to indicate whether a TES correction process is effective or not; a jump state flag tccon indicating an accelerated movement period, during which the optical pickup 400 is moved at accelerated speed, or a constant speed movement period, during which the optical pickup 400 is moved at constant speed; and a target track count value TC1 that is the number of tracks between the present scanning track position T1 and the target scanning track position T2. The microcomputer 500 also supplies to the two-input switch circuit 125 a switching signal SW for switching between two inputs.

The tracking signal generating circuit 121 generates a tracking signal TD for driving the driving coil of the servo mechanism 430 for tracking servocontrol based on the tracking error signal TE supplied from the TE/FE generating circuit 220, to be input to one of two input terminals of the two-input switch circuit 125. As described above, with respect to the two-input switch circuit 125, the tracking signal TD from the tracking signal generating circuit 121 is input to one input terminal thereof, and a track jump signal TJ generated by the track jump control circuit 150 is input to the other input terminal thereof. Based on the switching signal SW from the microcomputer 500, the two-input switch circuit 125 selects and outputs the tracking signal TD when performing tracking servocontrol, and selects and outputs the track jump signal TJ when performing the track jump.

At the servo mechanism 430, the driving coil is driven based on the tracking signal TD or the track jump signal TJ output from the two-input switch circuit 125, to perform tracking servocontrol or the short jump.

The track jump control circuit 150 includes a TES correction circuit 151, a track counter 152, and a track jump signal generating circuit 153.

The TES correction circuit 151 performs a TES correction process or a preinterpolation process, which will be described later, for disorder in relation to a pulse that may happen in the binarized tracking error signal TES due to the passage of the light spot S through the header portion 11. The TES correction process or preinterpolation process is performed based on the binarized tracking error signal TES supplied from the TE/FE generating circuit 220, the header portion detection signal CDET supplied from the header portion detection signal generating circuit 230, and the TES correction effective flag tccsw and jump state flag tccon that are supplied from the microcomputer 500. The track counter 152 counts the number of pulses of the binarized tracking error signal TES or of the correction signal TES′ resulting from the correction thereof, by detecting an edge of the binarized tracking error signal TES or of the correction signal TES′, both signals TES and TES′ being supplied from the TES correction circuit 151. The count value (hereinafter, referred to as “track count value TC2”) is equivalent to the number of tracks jumped by the light spot S during the track jump.

The track jump signal generating circuit 153 compares the track count value TC2 supplied from the track counter 152 with the target track count value TC1 supplied from the microcomputer 500, to generate and output the track jump signal TJ for driving the driving coil of the servo mechanism 430 so as to keep moving the scanning position of the optical pickup 400 until the track count value TC2 coincides with the target track count value TC1.

<Configuration of TES Correction Circuit>

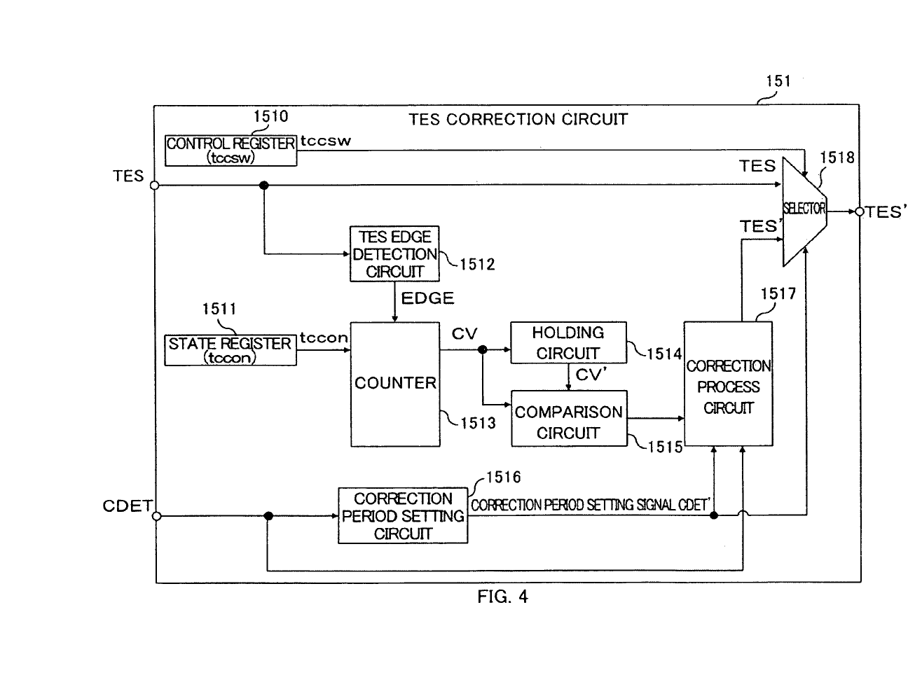

FIG. 4 is a diagram of a configuration of the TES correction circuit 151 according to one embodiment of the present invention.

A control register 1510 is a register for storing the TES correction effective flag tccsw supplied from the microcomputer 500. According to the present embodiment, it is assumed that the TES correction process is set to be noneffective when the TES correction effective flag tccsw is “0”, and is set to be effective when the TES correction effective flag tccsw is “1”. By providing the control register 1510, it becomes unnecessary to perform the TES correction process according to the present invention when performing the track jump for other type of an optical disc without the header portion 11 being set, as long as the header portion 11 of the optical disc is not set.

A state register 1511 is a register for storing the jump state flag tccon. According to the present embodiment, it is assumed that the jump state flag tccon having the value of “0” indicates the accelerated movement period of the optical pickup 400 during which the track count value TC2 is not fixable since the optical pickup 400 is in the unstable initial stage of movement, and the jump state flag tccon having the value of “1” indicates the constant speed movement period during which the track count value TC2 can be obtained normally since the optical pickup 400 moves stably at a constant speed.

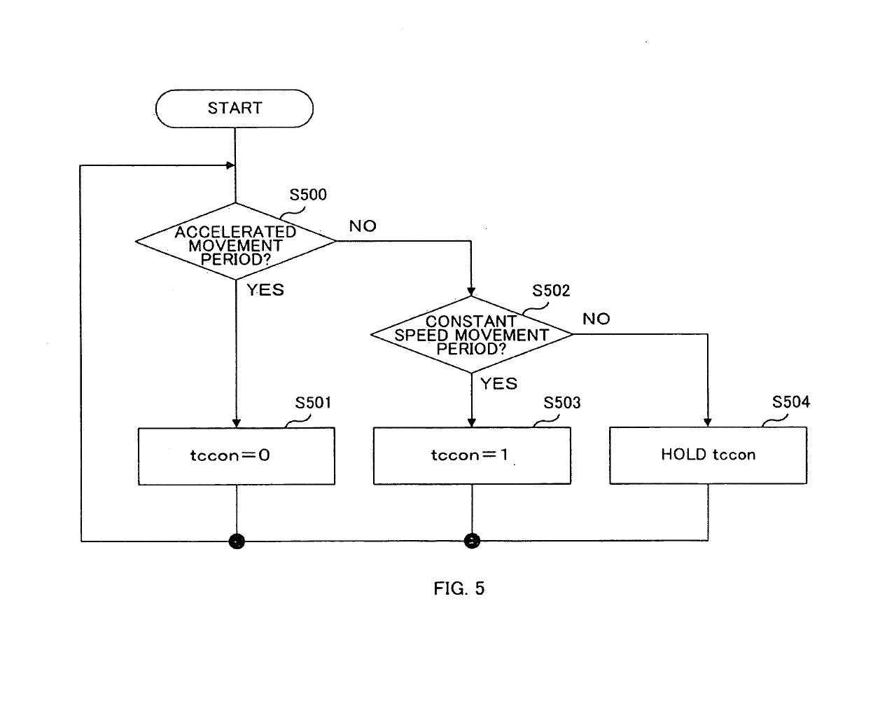

The jump state flag tccon is a flag for determining a jump state. To describe more specifically referring to FIG. 5, the microcomputer 500 sets the jump state flag tccon to “0” when the optical pickup 400 is in the accelerated movement period (YES at S500), and sets the jump state flag tccon to “1” when the optical pickup 400 is not in the accelerated movement period but in the constant speed movement period (NO at S500, YES at S502). When the optical pickup 400 is not in the accelerated movement period nor in the constant speed movement period (NO at S500, NO at S502), the microcomputer 500 holds the jump state flag tccon at the present bit value (S504).

The TES correction circuit 151 performs the TES correction process when the jump state flag tccon is “1”, and performs the preinterpolation process, which will be described later, when the jump state flag tccon is “0”. In other words, the TES correction circuit 151 performs the TES correction process in the case of the constant speed movement period, however, in the case of the accelerated movement period, the TES correction circuit 151 performs the preinterpolation process, which serves as a complement to the TES correction process, since the TES correction process does not work effectively due to unstableness of edge detection and edge interval counting of the binarized tracking error signal TES.

A TES edge detection circuit 1512 detects an edge of the binarized tracking error signal TES supplied from the TE/FE generating circuit 220, to generate and output an edge detection signal EDGE indicating the detection of the edge.

A counter 1513 counts in an edge interval of the binarized tracking error signal TES based on the edge detection signal EDGE from the TES edge detection circuit 1512 and the bit value of the jump state flag tccon stored in the state register 1511.

A holding circuit 1514 updates and holds a count value CV obtained in every interval between edges by the counter 1513. A comparison circuit 1515 compares a count value CV′ held in the holding circuit 1514 with the count value CV output from the counter 1513 at present. The result of comparison by comparison circuit 1515 is used for the TES correction process by a correction process circuit 1517.

A correction period setting circuit 1516 extends, for a certain period, the pulse width of the header portion detection signal CDET supplied from the header portion detection signal generating circuit 230, to generate and output a correction period setting signal CDET′ where the extended pulse width is set as a correction period for executing the TES correction process. The correction period should preferably be set shorter than one cycle of the binarized tracking error signal TES so as not to perform the TES correction process unnecessarily for a longtime. According to the present embodiment, the correction period setting circuit 1516 also plays a part in setting a preinterpolation period for executing the preinterpolation process.

A correction process circuit 1517 performs the TES correction process of generating the correction signal TES′ of the binarized tracking error signal TES when the header portion detection signal CDET is generated, using the count value CV′ held in the holding circuit 1514 and the binarized tracking error signal TES.

Specifically, using a comparison result from the comparison circuit 1515, the correction process circuit 1517 sets an edge interval of the correction signal TES′ based on the count value CV′ held in the holding circuit 1514, during the correction period indicated by the pulse width of the correction period setting signal CDET′ obtained by extending the pulse width of the header portion detection signal CDET.

The correction process circuit 1517 includes a data latch circuit, etc., that memorizes the level of the binarized tracking error signal TES at the time of formation of an edge of the header portion detection signal CDET, when the header portion detection signal CDET is generated. The correction process circuit 1517 generates the correction signal TES′ based on: the level of the binarized tracking error signal TES memorized in the data latch circuit, etc.; and a comparison result from the comparison circuit 1515.

The comparison circuit 1515 generates a timing signal for reversing the level of the correction signal TES′ when the present count value CV coincides with the count value CV′ held in the holding circuit 1514, and the correction process circuit 1517 reverses the level of the correction signal TES′ based on the timing signal supplied from the comparison circuit 1515. In other words, the correction process circuit 1517 uses a comparison result from the comparison circuit 1515 as the timing signal for switching between edges of the correction signal TES′, the timing signal being a signal for rising or falling an edge.

The selector 1518 selects and outputs either binarized tracking error signal TES supplied from the TE/FE generating circuit 220 or correction signal TES′ of the binarized tracking error signal TES, the correction signal TES′ being supplied from the correction process circuit 1517, based on the bit value of the TES correction effective flag tccsw stored in the control register 1510. That is, the selector 1518 is provided in combination with the control register 1510 to support various optical discs other than the optical disc 10.

The selector 1518 selects and outputs either binarized tracking error signal TES or correction signal TES′ corresponding to the header portion detection signal CDET indicating the passage of the optical pickup 400 through the header portion 11. Specifically, the selector 1518 selects and outputs the correction signal TES′ in the correction period indicated by the pulse width of the correction period setting signal CDET′, and outputs the binarized tracking error signal TES as it is in a period other than the correction period.

<Operation of TES Correction Circuit>

=TES Correction Process=

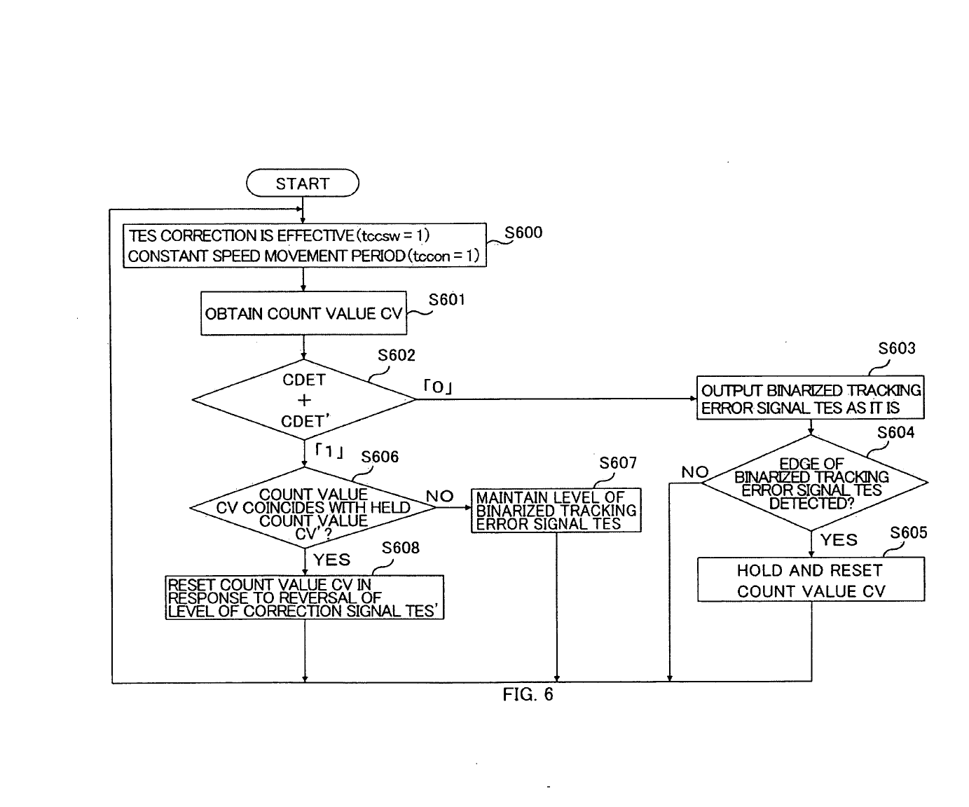

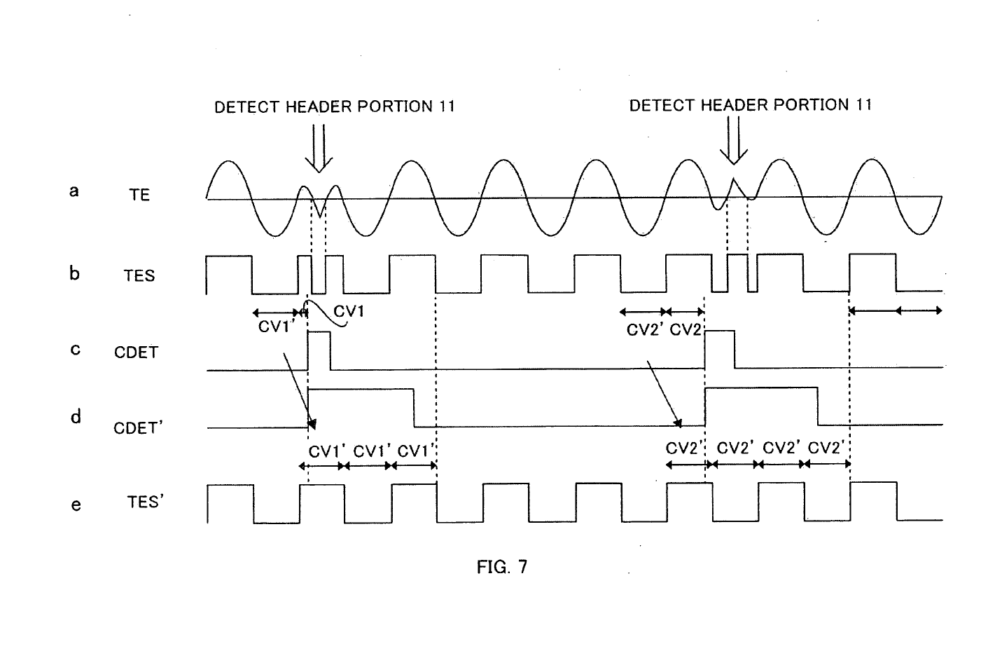

The TES correction process by the TES correction circuit 151 will be described referring to a flowchart of FIG. 6, and to FIG. 7 as needed.

First, it is assumed that the TES correction effective flag tccsw stored in the control register 1510 is set to “1”, and the jump state flag tccon stored in the state register 1511 is set to “1” (S600). That is, it is assumed that the TES correction process in the TES correction circuit 151 is set to be effective, and the scanning position of the optical pickup 400 is on the move from the present scanning track position T1 to the target scanning track position T2 in the constant speed movement period.

In this case, the tracking error signal TE takes a waveform showing one cycle in which each of the tracks between the present scanning track position T1 and the target scanning track position T2 is jumped, as shown in FIG. 7a, and the binarized tracking error signal TES becomes a pulse train corresponding to the number of cycles of the tracking error signal TE, as shown in FIG. 7b. In the TES correction circuit 151, the TES edge detection circuit 1512 detects an edge of the binarized tracking error signal TES, while the holding circuit 1514 updates and holds the count value obtained in every interval between edges, which is counted by the counter 1513 (S601).

When the light spot S passes the header portion 11, distortion occurs in the tracking error signal TE, as shown in FIG. 7a, which leads to the collapse of the sustained cyclical property of the binarized tracking error signal TES, as shown in FIG. 7b, thus brings a change in the pulse width of the binarized tracking error signal TES. At this time, the CDET generating circuit 230 generates the header portion detection signal CDET, as shown in FIG. 7c, and the correction period setting circuit 1516 generates the correction period setting signal CDET′ obtained by extending the header portion detection signal CDET in pulse width for a certain period, as shown in FIG. 7d.

Then, when the logical sum of the header portion detection signal CDET and the correction period setting signal CDET′ is “1”, the TES correction circuit 151 applies the TES correction process to the binarized tracking error signal TES (“1” at S602). That is, the TES correction circuit 1511, as shown in FIG. 7e, maintains the level of the binarized tracking error signal TES at the time of formation of a rising edge of the header portion detection signal CDET (S607), until the count value CV output from the counter 1513 at present coincides with the count value CV′ held in the holding circuit 1514 (YES at S606).

The TES correction circuit 151 reverses the level of the correction signal TES′ when the count value CV output from the counter 1513 at present coincides with the count value CV′ held in the holding circuit 1514, in the period until the end of the TES correction period (S608). The count value CV of the counter 1513 is reset every time the level of the correction signal TES′ is reversed (S608).

When the logical sum of the header portion detection signal CDET and the correction period setting signal CDET′ changes from “1” to “0”, (“0” at S602) and the TES correction period ends, it is assumed that a switch between rising and falling edges of the correction signal TES′ is not made in actuality, that is, an edge is not formed. Therefore, from the point of the end of the TES correction period to the point of detection of an edge of the binarized tracking error signal TES (No at S604), there is continued the TES correction process, and is maintained the level of the correction signal TES′ at the point of the end of the TES correction period, as it is (S603). Then, when the subsequent edge of the binarized tracking error signal TES is detected, the count value CV of the counter 1513 is held in the holding circuit 1514, and then is reset (S605).

As a result of the execution of the TES correction process as described above, the correction signal TES′ without the influence of the header portion 11 is generated, as shown in FIG. 7e, thereby the precision of the track jump is improved.

=Preinterpolation Process=

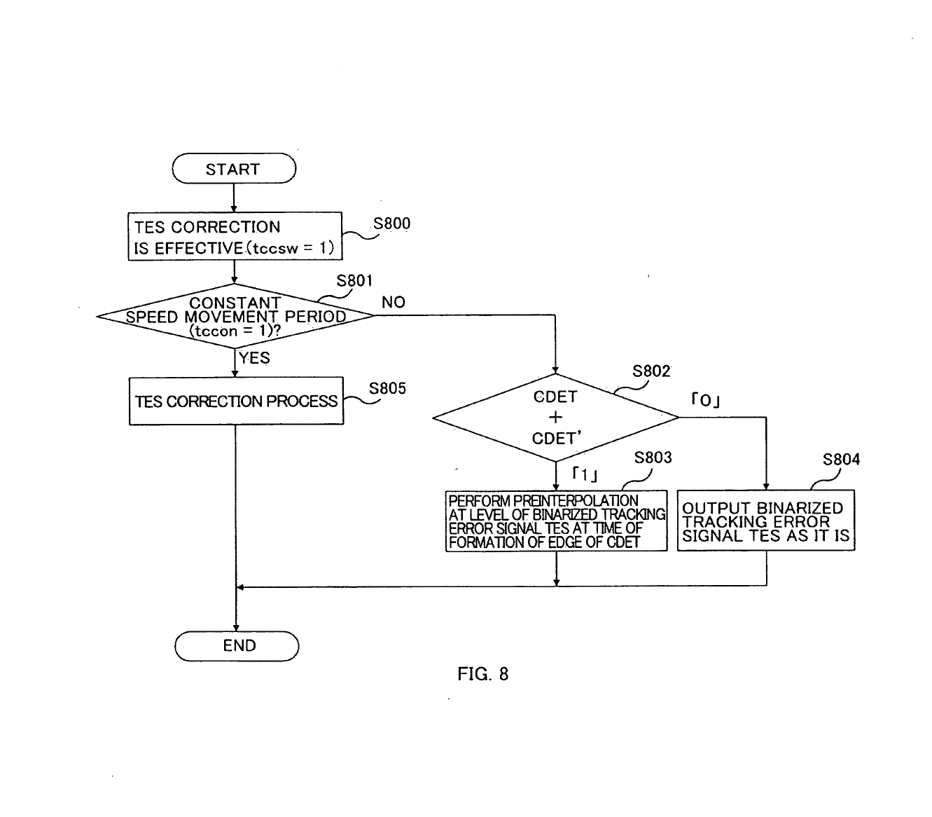

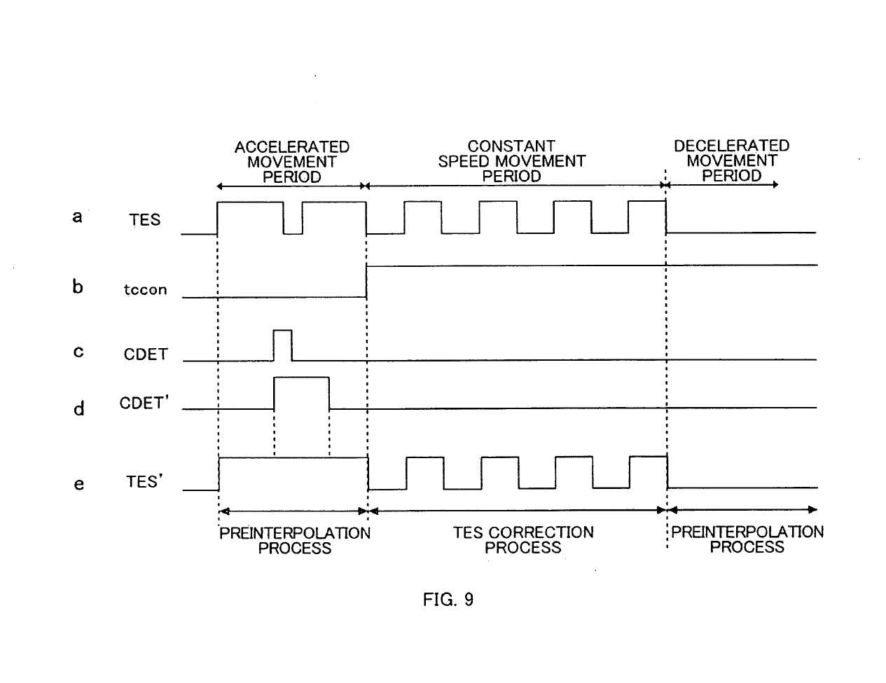

The preinterpolation process by the TES correction circuit 151 will be described referring to a flowchart of FIG. 8, and to FIG. 9 as needed.

First, the microcomputer 500 sets the TES correction effective flag tccsw stored in the control register 1510 to “1” (S800). In other words, the TES correction process executed in the TES correction circuit 151 is set to be effective.

When the light spot S track-jumps from the present scanning track position T1 to the target scanning track position T2, the accelerated movement period is assumed, in which period the cyclical property of the binarized tracking error signal TES is not established. In this case, the jump state flag tccon stored in the state register 1511 is set to “0” that indicates the accelerated movement period (No at S801).

In the accelerated movement period, as shown in FIG. 7a, the cyclical property of the binarized tracking error signal TES is not established, which makes the count value CV of the counter 1513 indefinite. As a result, it is difficult to execute the above TES correction process, even though a pulse width change occurs in the binarized tracking error signal TES due to the passage of the light spot S through the header portion. Therefore, the TES correction circuit 151 memorizes the level of the binarized tracking error signal TES at the time of a rising edge of the header portion detection signal CDET, and applies the preinterpolation process to the binarized tracking error signal TES at the above memorized level of the binarized tracking error signal TES.

Specifically, the TES correction circuit 151 maintains (preinterpolates) the level of the binarized tracking error signal TES at the time of a rising edge of the header portion detection signal CDET (S803) during a preinterpolation period, in which the logical sum of the header portion detection signal CDET and the correction period setting signal CDET′ is “1” (“1” at S802). After the logical sum of the header portion detection signal CDET and the correction period setting signal CDET′ changes from “1” to “0” (“0” at S802) to lead to the end of the preinterpolation period, the TES correction circuit 151 outputs the binarized tracking error signal TES as it is (S804).

As described above, the influence of the header portion 11 can be eliminated from the binarized tracking error signal TES in the accelerated movement period of the optical pickup 400, thereby the precision of the track jump is further improved.

When the optical pickup 400 makes a transition from the accelerated movement period to the constant speed movement period, the jump state flag tccon stored in the state register 1511 is set to “1” that indicates the constant speed movement period (YES at S801). As a result, the above TES correction process is performed (S805).

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A track jump control circuit performing control for an optical pickup to jump from a present scanning track position to a target scanning track position on an optical disc including a header portion on which header information is prerecorded and a data portion on which data is recorded, through counting the number of pulses of a binarized tracking error signal generated from reflected light from the optical disc received by the optical pickup, the track jump control circuit comprising:
a counter configured to count in an edge interval of the binarized tracking error signal;
a holding circuit configured to hold a count value obtained by the counter;
a correction process circuit configured to generate a correction signal of the binarized tracking error signal, using a count value held in the holding circuit and the binarized tracking error signal; and
a selector configured to select and output the binarized tracking error signal or the correction signal, corresponding to a header portion detection signal indicating passage of the optical pickup through the header portion.

2. The track jump control circuit of claim 1, further comprising
a comparison circuit configured to compare a count value held in the holding circuit with a count value output from the counter, wherein
the correction process circuit is configured to generate the correction signal using a comparison result obtained by the comparison circuit.

3. The track jump control circuit of claim 2, wherein
the correction process circuit is configured
to memorize a level of the binarized tracking error signal at a time of formation of an edge of the header portion detection signal when the header portion detection signal is generated, and
to generate the correction signal based on the memorized level of the binarized tracking error signal and a comparison result obtained by the comparison circuit.

4. The track jump control circuit of claim 3, wherein
the comparison circuit is configured to generate a timing signal when a count value held in the holding circuit coincides with a count value output from the counter, and wherein
the correction process circuit is configured to reverse a level of the correction signal based on the timing signal.

5. The track jump control circuit of claim 1, further comprising
a correction period setting circuit configured to generate a correction period setting signal obtained by extending a pulse width of the header portion detection signal, wherein
the selector is configured to select and output the binarized tracking error signal or the correction signal, corresponding to the correction period setting signal.

6. The track jump control circuit of claim 5, wherein
the correction process circuit is configured to generate the correction signal from a point of end of a correction period based on the correction period setting signal to a point of detection of an edge of the binarized tracking error signal.

7. The track jump control circuit of claim 1, further comprising
a state register configured to store a jump state flag indicating an accelerated movement period during which the optical pickup is moved at accelerated speed or a constant speed movement period during which the optical pickup is moved at constant speed, wherein
the correction process circuit is configured
to memorize a level of the binarized tracking error signal at a time of formation of an edge of the header portion detection signal when the jump state flag indicates the accelerated movement period and when the header portion detection signal is generated, and
to interpolate the binarized tracking error signal at the memorized level of the binarized tracking error signal for a predetermined period from a time of formation of an edge of the header portion detection signal, to generate the correction signal.
